(19) United States
(12) Patent Application Publication
(10) Pub. No.: US 2010/0180192 A1
(43) Pub. Date: Jul. 15, 2010

(54) DYNAMICALLY CONFIGURING A PRESENTATION LAYER ASSOCIATED WITH A WEBPAGE DELIVERED TO A CLIENT DEVICE

(75) Inventor: CLINT ANDREW HALL, Kansas City, MO (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION, INC., Overland Park, KS (US)

(21) Appl. No.: 12/351,440

(22) Filed: Jan. 9, 2009

(51) Int. Cl. G06F 17/00

(52) U.S. Cl. 715/234

(57) ABSTRACT

Methods, systems and media for dynamically configuring a presentation layer associated with a webpage delivered to a client device are provided. A request for a webpage is received and a number of static components of the webpage and a script are sent, the script being capable of determining a number of characteristics of the client device. A number of characteristics of the client device are received. One or more presentation-layer components of the webpage are determined based on the characteristics received. The presentation-layer component(s) of the webpage are sent to the client device.

### BACKGROUND

Webpages provided by web servers connected to the Internet support a wide variety of computing devices. New and more sophisticated user interface technologies, and the availability of higher bandwidth, promote the construction of more complex web pages. The diversity of computing devices (e.g., mobile handheld devices and desktop computers) has lead to websites being designed in multiple ways to support the varying capabilities of these client computing devices. In many cases, multiple instances of the same website are stored by a web server. The web server attempts to choose the correct version of the web page to deliver based on information about the connecting client.

### SUMMARY

Embodiments of the invention are defined by the claims below, not this Summary. A high-level overview of various embodiments of the invention is provided to introduce a selection of concepts that are further described below in the detailed description below. This Summary is not intended to identify key features or essential features of the claimed subject matter, nor is it intended to be used as an aid in isolation to determine the scope of the claimed subject matter.

Embodiments of the invention are related to dynamically configuring a presentation layer associated with a webpage. A request for a webpage is received. A number of static components of the webpage and a script are sent, the script capable of determining a number of characteristics of the client device. A number of characteristics of the client device are received. One or more presentation-layer components of the webpage are determined based on the characteristics received. The one or more presentation-layer components of the webpage are sent to the client device.

### BRIEF DESCRIPTION OF THE DRAWINGS

Illustrative embodiments of the invention are described in detail below with reference to the attached drawing figures, which are incorporated by reference herein and wherein:

FIG. 1 depicts a block diagram of an exemplary computing environment suitable for implementing embodiments of the invention;

FIG. 2 depicts a block diagram of an exemplary network environment suitable for implementing embodiments of the invention;

FIG. 3 depicts a diagram showing the structure of an Hyper-Text Markup Language document, in accordance with an embodiment of the invention;

FIG. 4 depicts a block diagram showing the elements of a webpage, in accordance with an embodiment of the invention;

FIG. 5 is a flow diagram showing a method of dynamically configuring a presentation layer associated with an webpage, in accordance with an embodiment of the invention;

FIG. 6 is a flow diagram showing a method of dynamically configuring a presentation layer associated with an webpage, in accordance with an embodiment of the invention; and

FIG. 7. is a schematic diagram showing the timing for a method of dynamically configuring a presentation layer associated with a webpage, in accordance with an embodiment of the invention.

### DETAILED DESCRIPTION

The subject matter of the invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention are directed to dynamically configuring a presentation layer associated with a webpage delivered to a client computing device. Webpages are delivered to client devices over a network connection by web servers. As the term is utilized herein, “web servers” are computing devices configured to store a plurality of webpages, accept requests from client devices, and deliver webpages in response to those client device requests. “Client devices,” as utilized herein, are any devices capable of requesting and displaying webpages. Client devices can have a wide variety of capabilities. For example, some client devices may have limited or no sound capabilities, while other devices may have poor screen resolution, and still other devices may have limited computation and memory resources. There are many other ways in which client devices could differ. Additionally, the method by which client devices connect to a web server may vary. For example, some client devices may connect using high-bandwidth wired links, while other devices may connect using lossy, low-bandwidth, wireless links. Such differences in device capabilities and connection characteristics may alter the way a webpage should be displayed or delivered to a client device.

Webpages are rendered by web browsers using a number of components, including Hyper-Text Markup Language (HTML) data, Cascading Style Sheets (CSS), various Metadata, and a plurality of scripts executable by the browser. These components can be divided into static components, those components that could be displayed on any client device, and presentation layer components, those components that may change depending on client device capabilities. For example, the basic HTML data defining the components and content of the webpage may be considered static data that may be displayed on any client. Particular CSS, metadata, and scripts that define the way that HTML data is rendered may be different for different clients and may be considered presentation-layer components, which may be dynamically changed based on client device capabilities.

Client device capabilities can be defined in terms of a number of characteristics. Each device may be defined in terms of computation and memory resources, which may affect the client device's ability to render complex webpage components rapidly (e.g., multimedia components such as Flash animations). Other characteristics that may affect the desired presentation of a webpage include screen size, screen resolution, script-language capabilities, vendor name, and color depth. Those skilled in the art will recognize that there are many other possible ways to characterize the capabilities of a client device that would affect the dynamic configuration of presentation layer technologies.

In addition to adjusting a number of presentation-layer components to be delivered to a client device based on client device characteristics, the method of delivery may also be adjusted. Web browsers may download and render various static and presentation-layer elements of a webpage differently depending on their placement within the webpage data. HTML files can include various presentation-layer components through the use of specialized tags placed in various locations within the static HTML components. Tags are used in HTML files to define element types within the webpage. For example, presentation-layer components may be placed within the HEAD tag of the HTML data for a webpage. This might cause the rendering of a webpage to be blocked by the downloading of all the presentation-layer components included in the HEAD tag. As another example, the presentation-layer components may be included using Document Object Model (DOM) inclusions. The DOM allows components of a webpage to be adjusted by presentation-layer components after the page has been transferred to the client device. As a further example, presentation-layer components may be included in phases, by loading a first set of presentation-layer components, where the first set of presentation-layer components includes a script that loads a second set of presentation-layer components.

An embodiment of the invention is directed to computer-readable media storing computer-executable instructions for performing a method of dynamically configuring a presentation layer associated with a webpage delivered to a client device. The method includes receiving a request for the webpage; sending one or more static components of the webpage and a script, the script being capable of determining one or more characteristics of the client device; receiving the one or more characteristics of the client device determined by the script; determining one or more presentation-layer components of the webpage to be delivered to the client device based on the one or more characteristics of the client device; and sending the one or more presentation-layer components of the webpage to the client device.

Another embodiment of the invention is directed to computer-readable media storing computer-executable instructions for performing a method of dynamically configuring a presentation layer associated with a webpage. The method includes acquiring one or more characteristics of a client device; sending an indication indicating the one or more characteristics of the client device; receiving one or more presentation-layer components of the webpage; and configuring the presentation layer of the webpage with the one or more presentation-layer components.

In yet another embodiment, the invention is directed to a method of dynamically configuring a presentation layer associated with a webpage delivered to a client device. The method includes receiving a request for the webpage; sending one or more static components of the webpage and a script, the script being capable of determining one or more characteristics of the client device; receiving the characteristic(s) of the client device determined by the script, wherein the characteristic(s) comprise one or more of screen height, screen width, IE version, color depth, java enabled, platform, and vendor; determining one or more presentation-layer components of the webpage to be delivered to the client device, wherein determining the presentation-layer component(s) comprises requesting a list of presentation-layer components from a rules engine based on the characteristic(s) of the client device; and sending the presentation-layer component(s) of the webpage to the client device, wherein the presentation-layer component(s) comprise one or more of cascading style sheets (CSS), JavaScript scripts, and metadata.

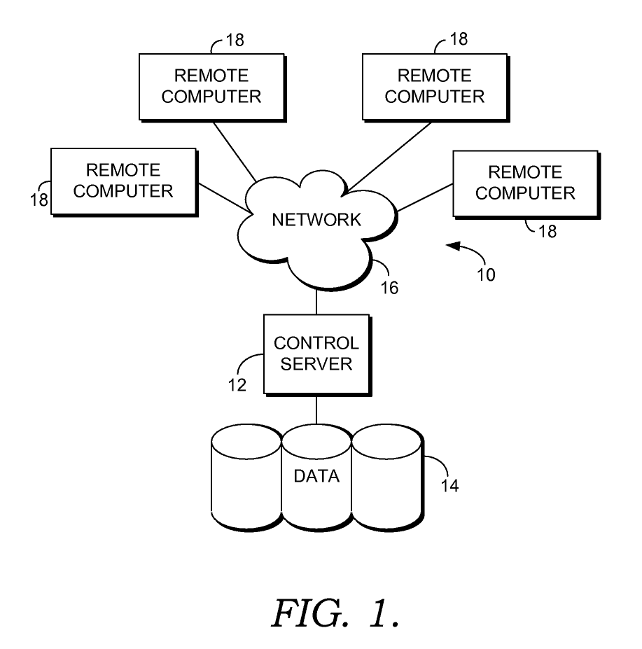

Having briefly described an overview of embodiments of the invention, an exemplary computing system environment 10 in which embodiments of the invention may be implemented is described below with reference to FIG. 1. It will be understood and appreciated by those of ordinary skill in the art that the illustrated computing system environment 10 is merely an example of one suitable computing environment and is not intended to suggest any limitation as to the scope of use or functionality of the invention. Neither should the computing system environment 10 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary computing system environment 10 includes a general purpose computing device in the form of a server 12. Components of the server 12 may include, without limitation, a processing unit, internal system memory, and a suitable system bus for coupling various system components, including database cluster 14, with the server 12. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 12 typically includes, or has access to, a variety of computer readable media, for instance, database cluster 14. Computer readable media can be any available media that may be accessed by server 12, and includes volatile and nonvolatile media, as well as removable and non-removable media. By way of example, and not limitation, computer readable media may comprise computer storage media. Computer storage media may include, without limitation, volatile and nonvolatile media, as well as removable and non-removable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 12. Combinations of any of the above also may be included within the scope of computer readable media.

The computer storage media discussed above and illustrated in FIG. 1, including database cluster 14, provide storage of computer readable instructions, data structures, program modules, and other data for the server 12.

The server 12 may operate in a computer network 16 using logical connections to one or more remote computers 18. The remote computers 18 may be personal computers, servers, routers, network PCs, peer devices, other common network nodes, or the like, and may include some or all of the elements described above in relation to the server 12. The devices can be personal digital assistants or other like devices.

Exemplary computer networks 16 may include, without limitation, local area networks (LANs) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 12, in the database cluster 14, or on any of the remote computers 18. For example, and not by way of limitation, various application programs may reside on the memory associated with any one or more of the remote computers 18. It will be appreciated by those of ordinary skill in the art that the network connections shown are exemplary and other means of establishing a communications link between the computers (e.g., server 12 and remote computers 18) may be utilized.

In operation, a user may enter commands and information into the server 12 or convey the commands and information to the server 12 via one or more of the remote computers 18 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 12. In addition to a monitor, the server 12 and/or remote computers 18 may include other peripheral output devices, such as speakers and a printer.

Although many other internal components of the server 12 and the remote computers 18 are not shown, those of ordinary skill in the art will appreciate that such components and their interconnection are well known. Accordingly, additional details concerning the internal construction of the server 12 and the remote computers 18 are not further disclosed herein.

Although methods and systems of embodiments of the present invention may be described as being implemented in a WINDOWS operating system, operating in conjunction with an Internet-based system, one of ordinary skill in the art will recognize that the described methods and systems can be implemented in any system supporting the receipt and processing of healthcare-related orders, particularly, molecular diagnostic orders. As contemplated by the language above, the methods and systems of embodiments of the present invention may also be implemented on a stand-alone desktop, personal computer, or any other computing device used in a healthcare environment or any of a number of other locations.

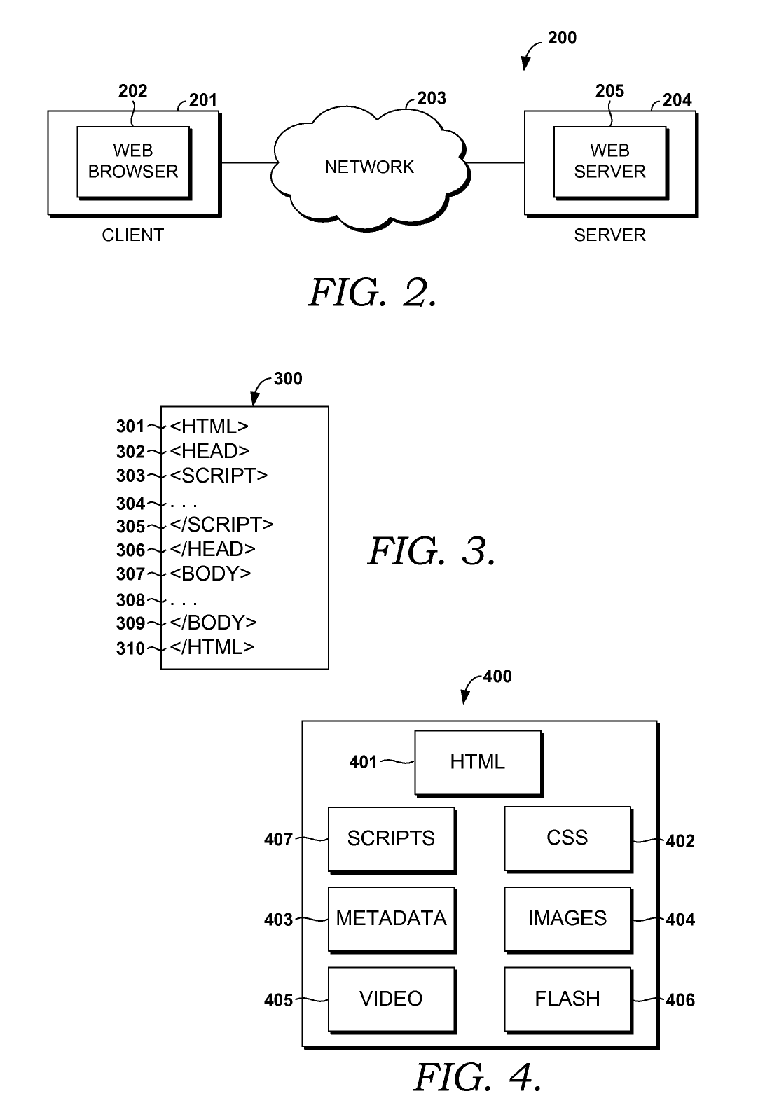

Referring now to FIG. 2, a block diagram illustrating an exemplary network environment 200 suitable for implementing embodiments of the invention is depicted. A client device 201 is connected to a network 203 via a connection using one or more of a number of possible network technologies. Such network technologies may include, without limitation, wired technologies (e.g., Ethernet and token ring) and wireless technologies (e.g., IEEE 802.11, WiMAX, and Bluetooth). The network technology used to connect the client device 201 to the network 203 can affect a number of network performance parameters. For example, the bit rate, latency, and loss rate could be affected by the network technology used to connect the client device 201 to the network 203. The network 203 could be any of a variety of networks, such as those described above with reference to network 16 of FIG. 1.

A server 204 is also connected to the network 203. The server 204 is configured to run a web server 205 to deliver webpages to client devices. The client device 201 is configured to run a web browser 202 that is operable to allow users to request webpages from the web server 205, receive data corresponding to the requested webpage, and render the webpage on the client device 201. There are many examples of web browsers suitable for requesting and rendering webpages. For example, the INTERNET EXPLORER, FIREFOX, OPERA, and LYNX are exemplary web browsers. The web browser 202 can be characterized by a number of capabilities, defining the web browser's ability to render presentation-layer components of a webpage. For example, some web browsers are configured to executed scripts. Scripts can allow dynamic configuration of a webpage as well as increased interactivity. JavaScript is an example of a scripting language suitable for the implementation of scripts deliverable with webpages. Those skilled in the art will recognize that there are other languages in which suitable scripts may be written.

Turning now to FIG. 3, a schematic diagram depicting typical parts of an HTML file 300 is illustrated. The HTML data is composed of data surrounded by tags. Tags inform the browser how the data between the tags should be interpreted. Tags are of the form “<name>data</name>”, where name is a keyword identifying the tag and data is the actual data to be rendered by the web browser. Tags are paired, having a beginning tag and an ending tag. The entire contents of the HTML file are encapsulated in “html” tags 301 and 310. The HTML document is divided into two main sections, a HEAD section, encapsulated in “head” tags 302 and 306, and a BODY section, encapsulated in “body” tags 307 and 309. The HEAD section may contain metadata describing the contents of the HTML document. Additionally, the HEAD section may contain one or more scripts to be executed. These scripts can attach additional functionality to the webpage, request other data to be added to the webpage, request other presentation-layer components to the webpage, and perform many other functions. Those skilled in the art will recognize that there are many purposes scripts might fulfill. Each set of scripts 304 is encapsulated in “script” tags 303 and 305. The BODY section contains the main content 308 to be rendered by the web browser. There are many different elements that can make up the body of an HTML document. For example, the BODY section can include text, images, video, FLASH, audio, input fields, buttons, and other interactive components.

Turning now to FIG. 4, a block diagram depicting various components of a webpage 400 is illustrated. The exemplary webpage 400 depicted includes a static component defined by the HTML data 401. This data can be organized similar to that shown in FIG. 3, and includes both data to be rendered by a web browser and various information about the contents of the webpage, including information on presentation-layer components. Those skilled in the art will recognize that each element could be located in many different sections of an HTML document. For example, scripts can be included in the HEAD section of an HTML document, as shown in FIG. 3, and in the BODY section of an HTML document. The webpage may contain a number of multimedia elements such as a video component 405, a number of images 404, and a FLASH animation 406. These components may be considered presentation-layer components, with some subset being displayed on various client devices depending on the characteristics particular to each client device.

The structure of the presentation-layer components as well as the way various data in the HTML file 401 is rendered may be controlled using Cascading Style Sheets (CSS) 402. CSS allows the method of rendering the data encapsulated by various tags to be explicitly defined. Additionally there may be a number of scripts 407 that affect the presentation-layer components, request additional presentation-layer components, and/or add other interactive functionality to the webpage. Metadata 403 could also be present to modify and define the webpage. For example, metadata 403 is often included to affect the way a webpage is indexed by various search engines.

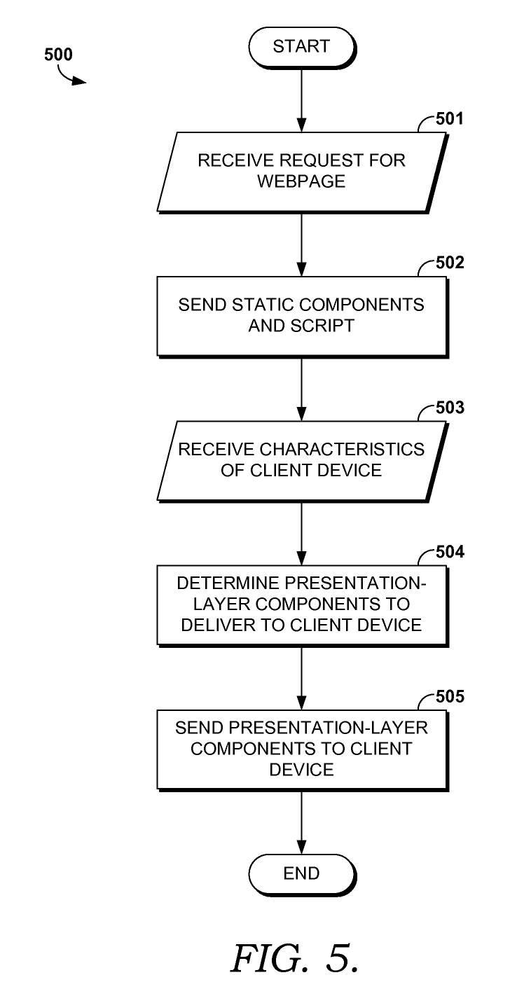

With reference to FIG. 5, a flow diagram illustrating a method 500 for dynamically configuring the presentation layer associated with a webpage delivered to a client is shown. A request for a webpage is received, as shown at block 501. A request for a webpage may be generated, for example, by a web browser running on a client device, and sent to a web server. In accordance with one embodiment of the present invention, the web server may be running on a computing device connected to a network accessible by the client device. The request may contain a number of different pieces of information. For example, the request may contain the address of the requested webpage and some information about the client device, such as what web browser is generating the request. Those skilled in the art will recognize that there are many other pieces of information that may be contained in the request for a webpage.

Static components of the request webpage and a script configured to determine the characteristics of the client device are returned in response to the request for a webpage, as shown at block 502. The static components may include, without limitation, any information that is to be rendered by the web browser, regardless of the characteristics of the client device. For example, text data including the information in the webpage may be contained in the static components. As another example, critical images may be contained in the static components. As a further example, certain metadata describing the webpage, such as search engine keywords and the title of the webpage. A script configured to gather information for use by the web server to further configure the presentation-layer of the webpage is also delivered in the response to the initial request. According to an embodiment of the invention, the script is included in the HEAD section of the HTML document delivered in response to the request for the webpage. Those skilled in the art will recognize that there are a number of languages suitable for the creation of the script. By way of example only, and not limitation, the script may be a JavaScript script. As another example, the script may be a link to a Java class object.

The script can be executed by the web browser, collecting various information characterizing the client device and sending it back to the web server. This information including various characteristics of the client device is received, as shown at block 503. There are a number of characteristics that may be useful in determining the correct configuration of the presentation layer of a webpage. For example, the characteristics might include screen height, screen width, INTERNET EXPLORER version number, color depth, java enabled information, platform, and vendor. Those skilled in the art will recognize that there are many possible characteristics that could be received for use in determining a configuration of the presentation layer of a webpage.

A number of presentation-layer components are determined to be delivered to the client device, as shown at block 504. Presentation-layer components might include a number of different types of data (e.g., CSS, scripts, Java objects, metadata, FLASH files, and images). According to one embodiment of the invention, presentation-layer components include a script operable to download further presentation-layer components from the web server upon execution.

There are a number of ways that presentation-layer components might be chosen. According to one embodiment, a rules engine is used to determine presentation-layer components to be sent to the client device. For example, an expressive, static-file-based, rules language driven rules engine may be given the characteristics received at block 503 as input. This rules engine could then output a list of presentation-layer components appropriate for client devices matching the profile defined by the received characteristics. According to another embodiment, a server-side script may be used to parse the received characteristics and return a list of presentation-layer components suitable for client devices matching a profile defined by the characteristics. Those skilled in the art will recognize that there are a number of server-side scripting languages suitable for writing the server-side script (e.g., PHP and Perl).

The determined, presentation-layer components are sent to the client device, as shown at block 505. According to an embodiment, a tag is sent and appended to the webpage. The tag may contain the address or Universal Resource Identifier (URI) of the script or other presentation-layer components to be included in the webpage. According to another embodiment, presentation-layer components may be sent as inclusions via the Document Object Model (DOM).

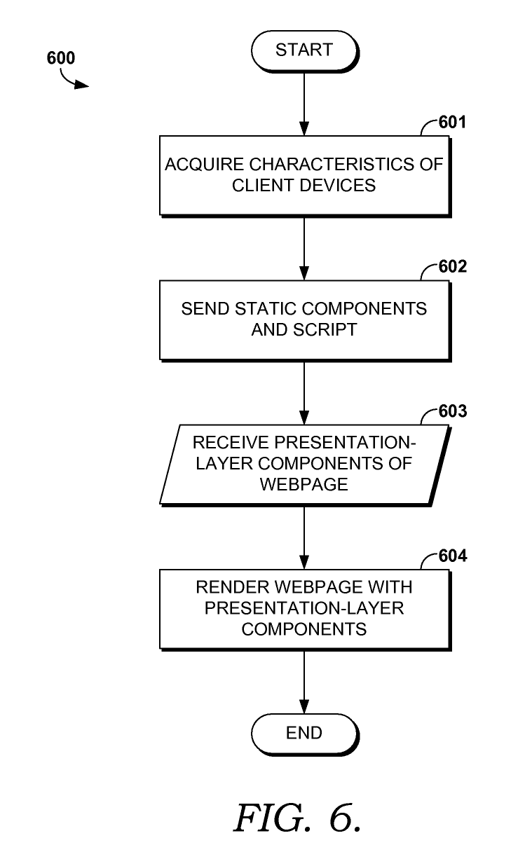

Turning now to FIG. 6, a flow diagram depicting a method 600 of dynamically configuring the presentation layer associated with a webpage is illustrated. A number of characteristics are acquired, as shown at block 601. According to an embodiment of the invention, a script that is included with the static components of a webpage is executed by the client browser. The script collects a number of characteristics of the client device (e.g., screen height, screen width, INTERNET EXPLORER version, color depth, java enabled, platform, and vendor). Those skilled in the art will recognize that there are a number of different languages suitable for writing the script (e.g., JavaScript).

The characteristics are sent to the web server, as shown at block 602. The server might be the same server that initial delivered the webpage. According to an embodiment, the server is configured to determine a number of presentation-layer components to be delivered and rendered as part of the webpage, based on a number of client-device characteristics. According to another embodiment, an indication of the characteristics of the client device is sent to the server by appending a script tag to the HTML document, where the script tag includes the characteristics to be sent to the server (e.g., the characteristics may be part of the appended Universal Resource Indicator (URI) designating the path to the script on the server). By way of example, the script tag may be appended to the HEAD section of the HTML document. As another example, the script tag may be appended to the BODY section of the HTML document.

A number of presentation-layer components are received to be rendered as part of the webpage, as shown at block 603. According to an embodiment of the invention, the presentation-layer components are received as a number of paths to be appended to the HTML document. According to another embodiment, a script or a path to a script is returned. The script may be operable to download and append a further set of presentation-layer components to the webpage. The webpage is rendered with the presentation-layer components, as shown at block 604. According to an embodiment of the invention, the webpage may have the static components, re-rendered to include the presentation-layer commands and components rendered and used. According to another embodiment of the invention, the webpage could be delayed in being rendered until all presentation-layer components have been received. Those skilled in the art will recognize there are a number of ways the webpage may be rendered to include the presentation-layer components, and embodiments of the present invention are not limited to any particular method.

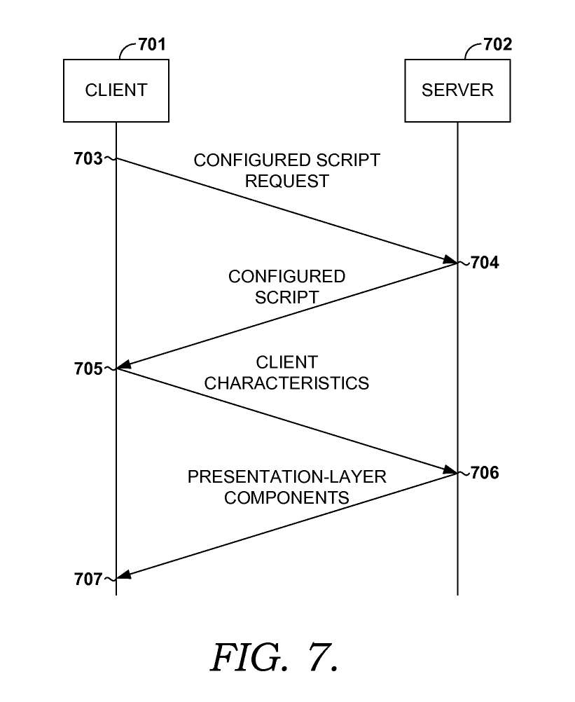

Turning now to FIG. 7, a schematic diagram depicting the timing of a method for dynamically configuring the presentation-layer associated with a webpage is illustrated. A client device 701 is connected to a server 702 via a network. The client device is running a web browser capable of requesting and rendering a webpage. The server is running a web server capable of delivering a webpage, including a number of presentation-layer components. The client device, at time 703, requests a configured script. The configured script request may be generated, for instance, by an initial script included as a response to a request for a webpage. The configured-script request is received at the server at time 704 and delivers a configured script. The configured script is operable to determine a number of client-device characteristics and return them to the server for use in determining a number of presentation-layer components.

At time 705, the configured script is received by the client and executed. The script collects a number of client characteristics, such as screen size and color depth, and sends them to the server. The characteristics are received by the server at time 706 and used to determine a number of presentation-layer components to be rendered with the webpage. According to an embodiment of the invention, a rules engine is used to determine a number of presentation-layer components appropriate for client devices matching a profile determined by the characteristics received. A number of presentation-layer components are returned to the client device. At time 707, the client device receives the determined presentation-layer components. The web browser executing on the client device renders the webpage with the received presentation-layer components.

Many different arrangements of the various components depicted, as well as components not shown, are possible without departing from the spirit and scope of embodiments of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of embodiments of the invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media storing computer-executable instructions for performing a method of dynamically configuring a presentation layer associated with a webpage delivered to a client device, the method comprising:
receiving a request for the webpage;
sending one or more static components of the webpage and a script, the script being capable of determining one or more characteristics of the client device;
receiving the one or more characteristics of the client device determined by the script;
determining one or more presentation-layer components of the webpage to be delivered to the client device based on the one or more characteristics of the client device; and
sending the one or more presentation-layer components of the webpage to the client device.

2. The media of claim 1, wherein each of the one or more static components comprise one or more of HTML tags, images, and static scripts.

3. The media of claim 1, wherein the script is a JavaScript script.

4. The media of claim 1, wherein each of the one or more characteristics comprises screen height, screen width, IE version, color depth, java enabled, platform, and vendor.

5. The media of claim 1, wherein the presentation-layer components comprise one or more of cascading style sheets (CSS), JavaScript scripts, Java objects, and metadata.

6. The media of claim 1, wherein the presentation-layer components comprise scripts containing executable instructions for requesting further presentation layer components.

7. The media of claim 6, wherein the further presentation-layer components comprise one or more of Flash files, images, Java objects, and metadata.

8. The media of claim 1, wherein determining one or more presentation-layer components of the webpage to be delivered comprises requesting a list of presentation-layer components from a rules engine based on the one or more characteristics of the client device.

9. The media of claim 8, wherein the rules engine comprises an expressive, static-file-based, rules language driven rules engine.

10. One or more computer-readable storage media storing computer-executable instructions for performing a method of dynamically configuring a presentation layer associated with a webpage, the method comprising:
acquiring one or more characteristics of a client device;
sending an indication indicating the one or more characteristics of the client device;
receiving one or more presentation-layer components of the webpage; and
configuring the presentation layer of the webpage with the one or more presentation-layer components.

11. The media of claim 10, wherein acquiring one or more characteristics of a client device comprises acquiring the one or more characteristics with JavaScript.

12. The media of claim 10, wherein the one or more characteristics comprise one or more of screen height, screen width, IE version, color depth, java enabled, platform, and vendor.

13. The media of claim 10, wherein sending an indication comprises appending a tag to the webpage.

14. The media of claim 13, wherein appending a tag to the webpage comprises appending a script tag to the head section of the webpage.

15. The media of claim 13, wherein the script tag includes a path to a script and the one or more characteristics to be sent.

16. The media of claim 15, wherein the path to a script comprises a Universal Resource Identifier identifying a server process.

17. The media of claim 10, wherein at least one of the one or more presentation-layer components comprises metadata, cascading style sheets (CSS), and JavaScript file paths.

18. The media of claim 17, wherein configuring the presentation layer of the webpage with the one or more presentation-layer components comprises appending the metadata, cascading style sheets (CSS), and JavaScript file paths to the webpage.

19. The media of claim 18, wherein appending the metadata, cascading style sheets (CSS), and JavaScript file paths to the webpage comprises appending the metadata, cascading style sheets (CSS), and JavaScript file paths to the head section of the webpage.

20. A method of dynamically configuring a presentation layer associated with a webpage delivered to a client device, the method comprising:
receiving a request for the webpage;
sending one or more static components of the webpage and a script, the script being capable of determining one or more characteristics of the client device;
receiving the one or more characteristics of the client device determined by the script, wherein each of the one or more characteristics comprises one of screen height, screen width, IE version, color depth, java enabled, platform, and vendor;
determining one or more presentation-layer components of the webpage to be delivered to the client device, wherein determining one or more presentation-layer components comprises requesting a list of presentation-layer components from a rules engine based on the one or more characteristics of the client device; and
sending the one or more presentation-layer components of the webpage to the client device, wherein at least one of the one or more presentation-layer components comprises cascading style sheets (CSS), JavaScript scripts, and metadata.
